(19) United States
(12) Patent Application Publication
(10) Pub. No.: US 2012/0250814 A1
(43) Pub. Date: Oct. 4, 2012

(54) NUCLEAR FUEL ASSEMBLY SUPPORT GRID

(75) Inventors: Joonhyung Choi, Lexington, SC (US); Yu Chung Lee, Columbia, SC (US)

(73) Assignee: Westinghouse Electric Company LLC, Cranberry Township, PA (US)

(21) Appl. No.: 13/074,064

(22) Filed: Mar. 29, 2011

(51) Int. Cl. G21C 3/356

(52) U.S. Cl. 376/442

(57) ABSTRACT

A spacer grid for a nuclear fuel assembly that exhibits increased crush strength. Each grid strap at the ligaments that support fuel rods has a spring or dimple to support the fuel rods under anticipated external loads during shipping and handling or in a seismic event. One or more elongated embossed ribs are provided on each of the fuel rod grid strap support ligaments to increase its moment of inertia by forming various shapes on the ligaments of the grid strap. Preferably, the ribs have a streamlined shape to prevent any excessive pressure drop. In this manner, the crush strength of a conventional short grid strap is increased without meaningful additional manufacturing costs or adverse effects to the neutron economy of the grid.

### BACKGROUND

1. Field

This invention pertains generally to a nuclear reactor fuel assembly and, more particularly, to a nuclear fuel assembly that employs a robust spacer grid.

2. Description of the Related Art

The primary side of nuclear reactor power generating systems which are cooled with water under pressure comprises a closed circuit which is isolated and in heat exchange relationship with a secondary circuit for the production of useful energy. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump, and a system of pipes which are connected to the vessel form a loop of the primary side.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water, is pumped into the vessel 10 by pump 16 through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by reactor coolant piping 20.

An exemplary reactor design is shown in more detail in FIG. 2. In addition to the core 14 comprised of a plurality of parallel, vertical, co-extending fuel assemblies 22, for purpose of this description, the other vessel internal structures can be divided into lower internals 24 and upper internals 26. In conventional designs, the lower internals' function is to support, align and guide core components and instrumentation as well as direct flow within the vessel. The upper internals restrain or provide a secondary restraint for the fuel assemblies 22 (only two of which are shown for simplicity in FIG. 2), and support and guide instrumentation and components, such as control rods 28. In the exemplary reactor shown in FIG. 2, coolant enters the reactor vessel 10 through one or more inlet nozzles 30, flows down through an annulus between the vessel and the core barrel 32, is turned 180° in a lower plenum 34, passes upwardly through a lower support plate 37 and a lower core plate 36 upon which the fuel assemblies are seated and through and about the assemblies. In some designs, the lower support plate 37 and the lower core plate 36 are replaced by a single structure, a lower core support plate having the same elevation as 37. The coolant flow through the core and surrounding area 38 is typically large on the order of 400,000 gallons per minute at a velocity of approximately 20 feet per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially outward to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. Support columns are respectively aligned above selected fuel assemblies 22 and perforations 42 in the upper core plate 40.

Rectilinearly moveable control rods 28, which typically include a drive shaft 50 and spider assembly 52 of neutron poison rods, are guided through the upper internals 26 and into aligned fuel assemblies 22 by control rod guide tubes 54. The guide tubes are fixedly joined through the upper support assembly 46 and the top of the upper core plate 40. The support column 48 arrangement assists in retarding guide tube deformation under accident conditions which could detrimentally effect control rod insertion capability.

FIG. 3 is an elevational view, represented in vertically shortened form, of a fuel assembly being generally designated by reference character 22. The fuel assembly 22 is the type used in a pressurized water reactor and has a structural skeleton, which at its lower end includes a bottom nozzle 58. The bottom nozzle 58 supports the fuel assembly 22 on the lower core plate 36 in the core region of the nuclear reactor. In addition to the bottom nozzle 58, the structural skeleton of the fuel assembly 22 also includes a top nozzle 62 at its upper end and a number of guide tubes or thimbles 84 which align with the guide tubes 54 in the upper internals. The guide tubes or thimbles 84 extend longitudinally between the bottom and top nozzles 58 and 62 and at opposite ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. A plan view of a grid 64 without the guide thimbles 84 and fuel rods 66 is shown in FIG. 4. The guide thimbles 84 pass through the cells labeled 96 and the fuel rods occupy the cells 94. As can be seen from FIG. 4, the grids 64 are conventionally formed from an array of orthogonal straps 86 and 88 that are interleaved in an egg-crate pattern with the adjacent interface of four straps defining approximately square support cells through which the fuel rods 66 are supported in the cells 94 in transverse, spaced relationship with each other. In many designs, springs 90 and dimples 92 are stamped into the opposite walls of the straps that form the support cells 94. The springs and dimples extend radially into the support cells and capture fuel rods 66 therebetween; exerting pressure on the fuel rod cladding to hold the rods in position. The orthogonal array of straps 86 and 88 is welded at each strap end to a bordering strap 98 to complete the grid structure 64. Also, the assembly 22, as shown in FIG. 3, has an instrumentation tube 68 located in the center thereof that extends between and is captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grids 64 spaced along the fuel assembly length. Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material are responsible for creating the reactive power of the reactor. The cladding which surrounds the pellets functions as a barrier to prevent the fission by-products from entering the coolant and further contaminating the reactor system.

To control the fission process, a number of control rods 78 are reciprocally moveable in the guide thimbles 84 located at predetermined positions in the fuel assembly 22. The guide thimble locations can be specifically seen in FIG. 4 represented by reference character 96, except for the center location which is occupied by the instrumentation tube 68. Specifically, a rod cluster control mechanism 80 positioned above the top nozzle 62, supports a plurality of control rods 78. The control mechanism has an internally threaded cylindrical hub member 82 with a plurality of radially extending flukes or arms 52 that form the spider previously noted with regard to FIG. 2. Each arm 52 is interconnected to a control rod 78 such that the control rod mechanism 80 is operable to move the control rods vertically in the guide thimbles 84 to thereby control the fission process in the fuel assembly 22, under the motive power of a control rod drive shaft 50 which is coupled to the control rod hub 80, all in a well known manner.

As mentioned above, the fuel assemblies are subject to hydraulic forces that exceed the weight of the fuel rods and thereby exert significant forces on the fuel rods and the assemblies. In addition, there is significant turbulence in the coolant in the core caused by mixing vanes on the upper surfaces of the straps of many grids which promote the transfer of heat from the fuel rod cladding to the coolant. The significant rate of flow of the coolant and the turbulence exert substantial forces on the grid straps. In addition, the grid straps have to withstand external loads incurred during shipping and handling or from all postulated accidents such as seismic and loss of coolant accidents. Recently, the concerns over seismic events at nuclear power plants has received more attention, resulting in a tightening of the seismic requirements that fuel assemblies have to satisfy. Typically, the fuel assembly grids have been strengthened by increasing the strap height, or the strap thickness or by adding additional welds. However, each of these design improvements results in an increased pressure drop of the coolant across the fuel assembly as well as added costs to the manufacturing process. For example, a high strength strap height of 2.25 inches (5.72 cm) that is 1.5 times taller than the standard height of 1.50 inches (3.81 cm) would increase the pressure drop across the grid assembly by approximately 10%. Additionally, adding a weld at the middle of the intersection of the grid straps to increase its crush strength, would add to the manufacturing costs.

Accordingly, a new fuel assembly grid design is desired that will increase the strength of the grid without significantly increasing the manufacturing costs or pressure drop across the grid.

### SUMMARY

A new support grid for a nuclear fuel assembly is herein provided that will fulfill the foregoing objectives. The new support gird, for supporting elongated fuel elements along the longitudinal dimension, includes a lattice structure which defines a plurality of cells, some of through which the fuel elements are respectively supported. Others of the cells respectively support guide tubes for control rods. Each of the cells has a plurality of walls which intersect at the corners of the cells and surround the corresponding fuel element or guide tube at the support locations. At least one wall of each cell that supports the fuel elements has an elongated rib formed from an indentation within the wall, that is an integral part of the wall, without substantially any perforations along the periphery of the indentation.

In one embodiment, the support grid has the elongated rib oriented substantially in the horizontal direction. Desirably, the elongated rib extends substantially the entire width between the corners of the walls. Preferably, the indentation is discontinued substantially at the corners. In the preferred embodiment, each of the cells that support fuel elements has an upstream end and a downstream end, wherein the upstream end first encounters a reactor coolant flow when the fuel assembly is situated in an operating reactor. Preferably, the surfaces of the indentation are rounded on the upstream side of the indentation and more desirably, all of the surfaces of the indentation are rounded to reduce pressure drop.

In another embodiment, the at least one wall has a plurality of the elongated ribs and preferably they are located at an elevation on either side of a dimple or spring that is employed to restrain vertical movement of the fuel rod.

In another embodiment, the lattice structure, in part, is made up of two parallel arrays of intersecting straps with the walls on a strap of adjacent cells that support fuel rods having an elongated rib formed in different directions. Preferably, all of the walls of each cell that supports the fuel elements has the elongated rib.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which this invention can be applied;

FIG. 2 is an elevational view, partially in section of a nuclear reactor vessel and internal components to which this invention can be applied;

FIG. 3 is an elevational view, partially in section of a fuel assembly illustrated in vertically shortened form, with parts broken away for clarity;

FIG. 4 is a plan view of an egg-crate support grid of this invention;

FIG. 5 is a perspective view of two cell portions of one grid strap of the grids shown in FIG. 4, that borders two fuel support cells with the cell strap section showing the ribs of this invention;

FIG. 6 is a perspective rear view of the grid strap section shown in FIG. 5;

FIG. 7 is a front perspective view of the grid strap cell sections shown in FIG. 5, with the elongated ribs oriented on a diagonal;

FIG. 8 is a perspective rear view of the grid strap cell sections shown in FIG. 7; and

FIGS. 9A-9G are side cross sectional views, respectively, of different grid strap rib contours that can be applied in accordance with this invention.

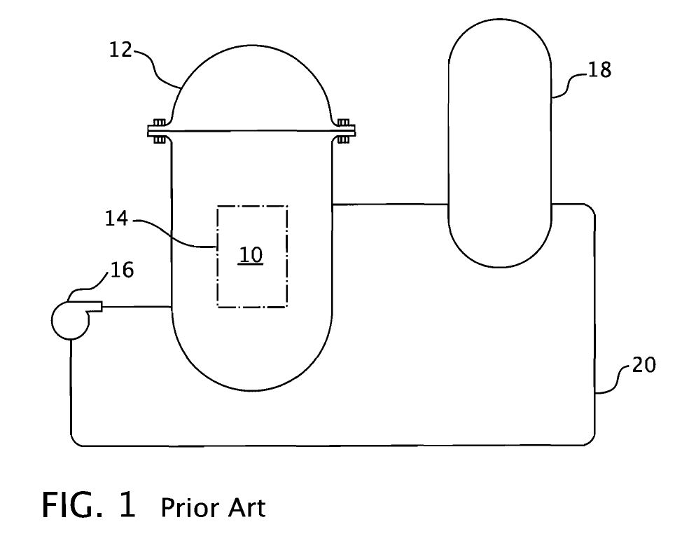

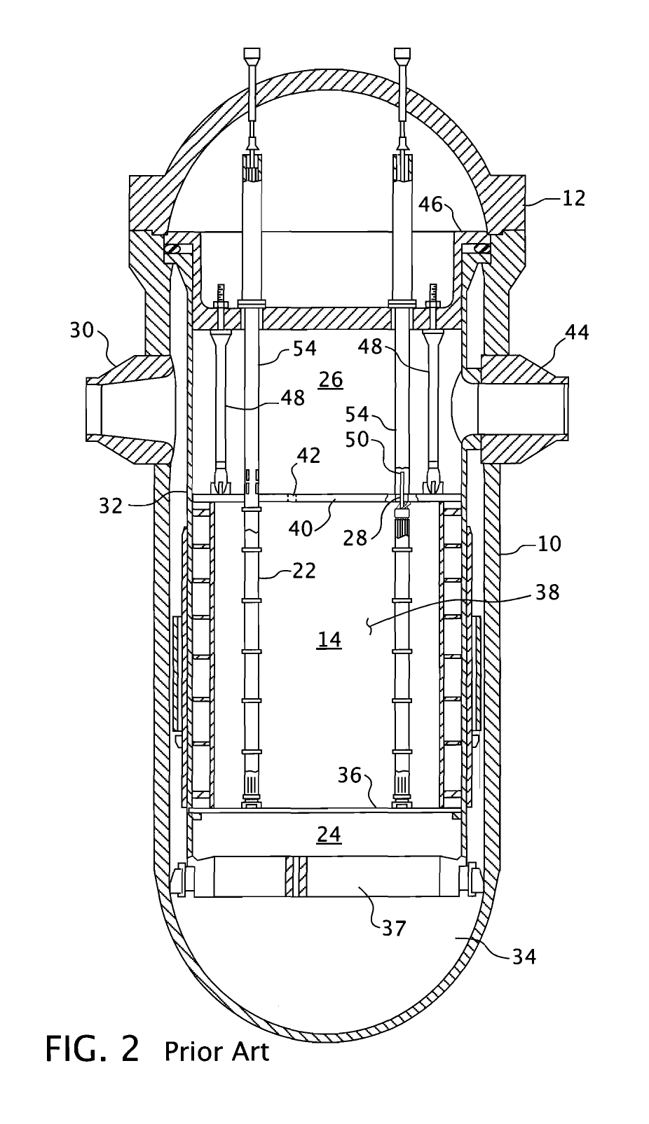

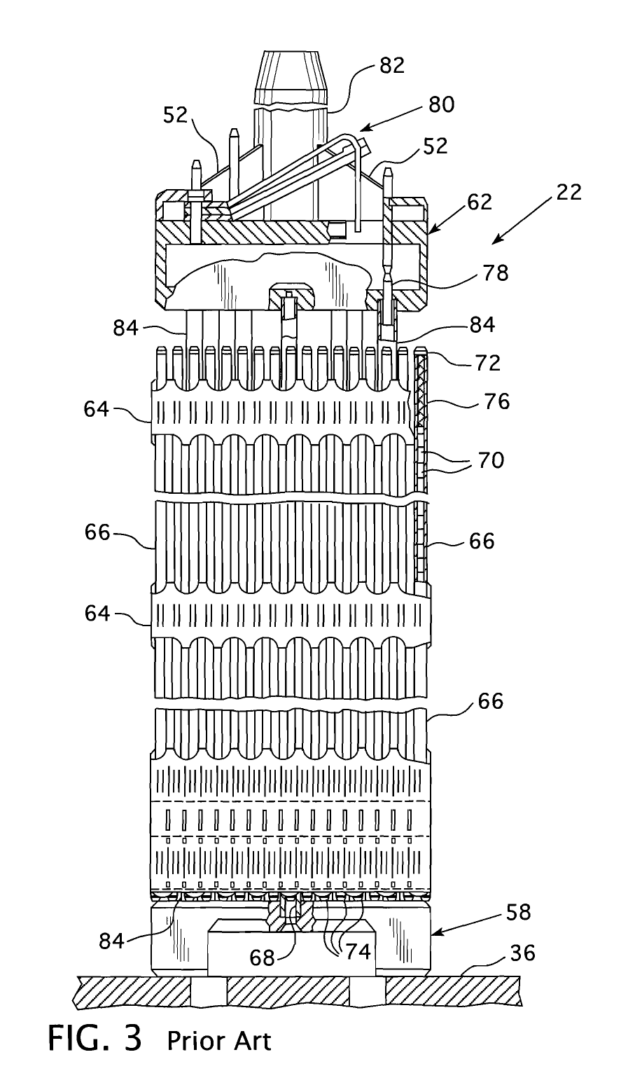

### DESCRIPTION OF THE PREFERRED EMBODIMENTS

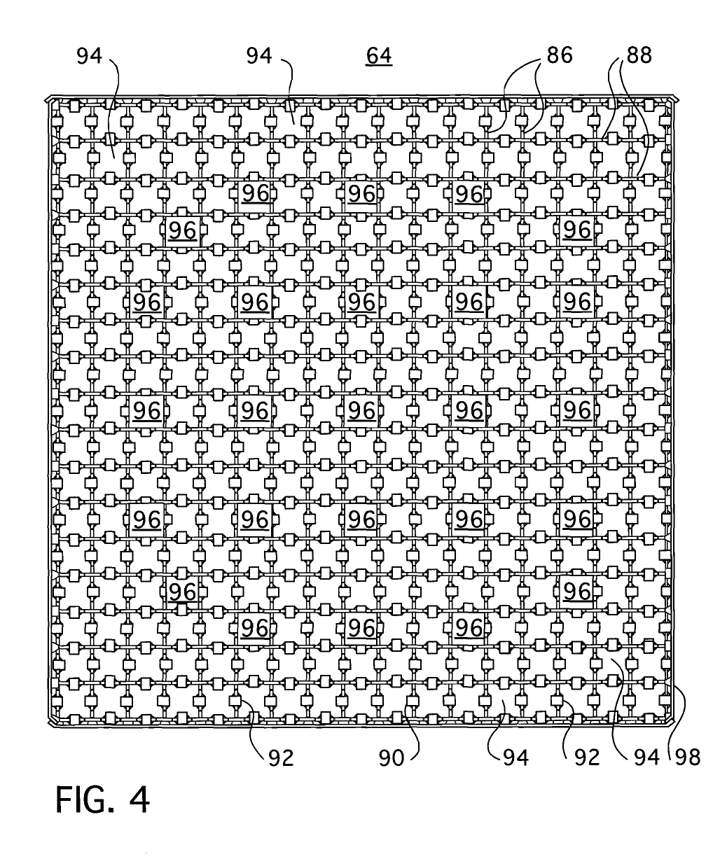

This invention provides a new fuel assembly design for a nuclear reactor and more particularly an improved spacer grid design for a nuclear fuel assembly. The improved grid is generally formed from a matrix of approximately square (or hexagonal) cells, some of which 94 support fuel rods while others of which 96 are connected to guide thimbles and a central instrumentation tube. The plan view shown in FIG. 4 looks very much like the prior art grids since contour of the individual grid straps 86 an 88 that incorporate the features of the embodiments described herein are not readily apparent from this view, but can be better appreciated from the view shown in FIGS. 5-9. The grid of this embodiment is formed from two orthogonally positioned sets of parallel, spaced straps 86 and 88, that are interleaved in a conventional manner and surrounded by an outer strap 98 to form the structural make-up of the grids 64. Though orthogonal straps 86 and 88 forming substantially square fuel rod support cells are shown in this embodiment, it should be appreciated that this invention can be applied equally as well to other grid configurations, e.g., hexagonal grids. The orthogonal straps 86 and 88 and in the case of the outer rows the outer straps 98, define the support cells 94 at the intersection of each four adjacent straps that surround the nuclear fuel rods 66. A length of each strap along the straps elongated dimension between the intersections of four adjacent straps forms a wall 100 of the fuel rod support cells 94.

FIGS. 5 and 6, and 7 and 8, each illustrate two walls 100 of adjacent cells 94 that support fuel rods that have many of the features of conventional grid straps 86 or 88 shown in FIG. 4. Though FIG. 4 illustrates a 17×17 array of cells, it should be appreciated that the application of the principals of this invention are not affected by the number of fuel elements in an assembly. The lattice straps which form the orthogonal members 86 and 88 shown in FIG. 4 are substantially identical in design. While the lattice straps 86 and 88 are substantially identical, it should be appreciated that the design of some of the lattice straps will vary from other lattice straps, to accommodate guide tube and instrument thimble locations identified by reference character 96. As can be best appreciated by reference to FIGS. 5-8, most of the walls 100 of the cells 94 that accommodate fuel elements are provided with a number of stamped protruding segments that are tooled by appropriate dies as is known and used in the industry. The upper and lower stamped segments 92 bulge out in one direction and form dimples for supporting the fuel elements against juxtaposed diagonal springs 90 which protrude from the opposite cell wall. The remaining centrally located, stamped section 90 in the same wall 100 as the previously described dimples 92, bulges in the opposite direction into the adjacent cells and forms a diagonal spring 90 for pressuring the fuel element against dimples 92 which protrude into that adjacent cell from its opposite wall. A preferred design of the diagonal spring can better be appreciated by reference to U.S. Pat. No. 6,144,716, issued Nov. 7, 2000.

Mixing vanes 102 extend from the upper edges of the lattice straps at some of the segments which form the walls of the cells 94 through which the fuel elements pass. The cells 96 that support the guide tubes and an instrumentation thimble through which the control rods and the in-core instrumentation pass differ from the fuel element support cells 94 in that they have none of the support members 90 or 92 protruding into their interior or mixing vanes 102 extending from their walls. The cells 96 may further differ in that they may have a concave, embossed section at the center of the cell walls extending from the bottom to the top of the lattice strap as described in U.S. Pat. No. 6,526,116, issued Feb. 25, 2003.

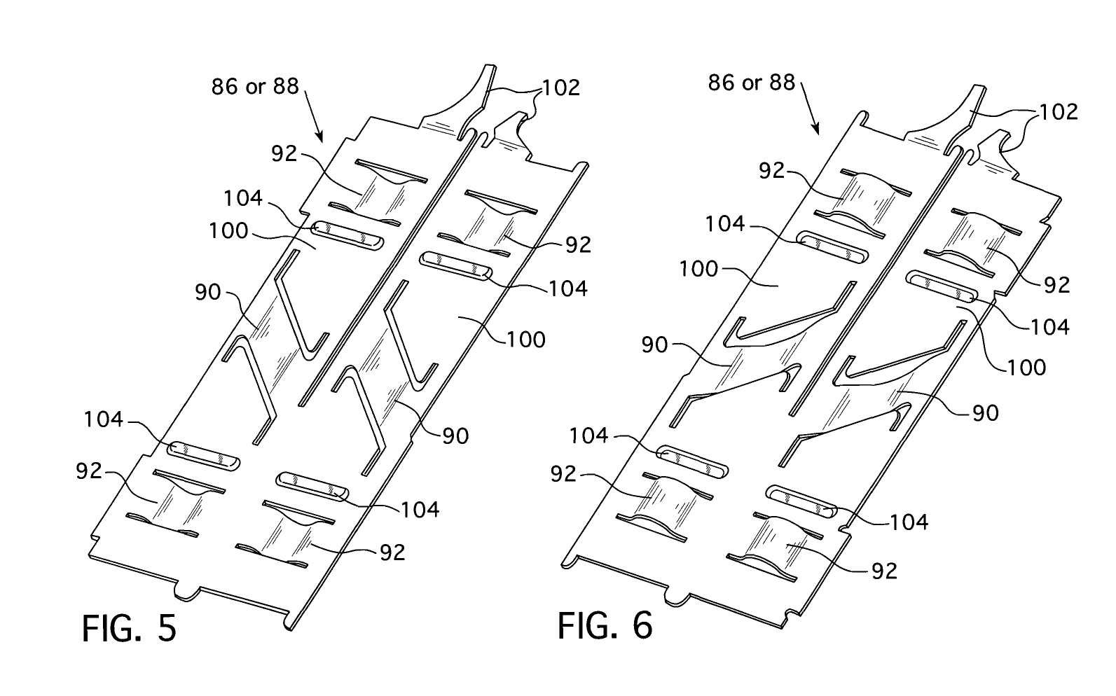

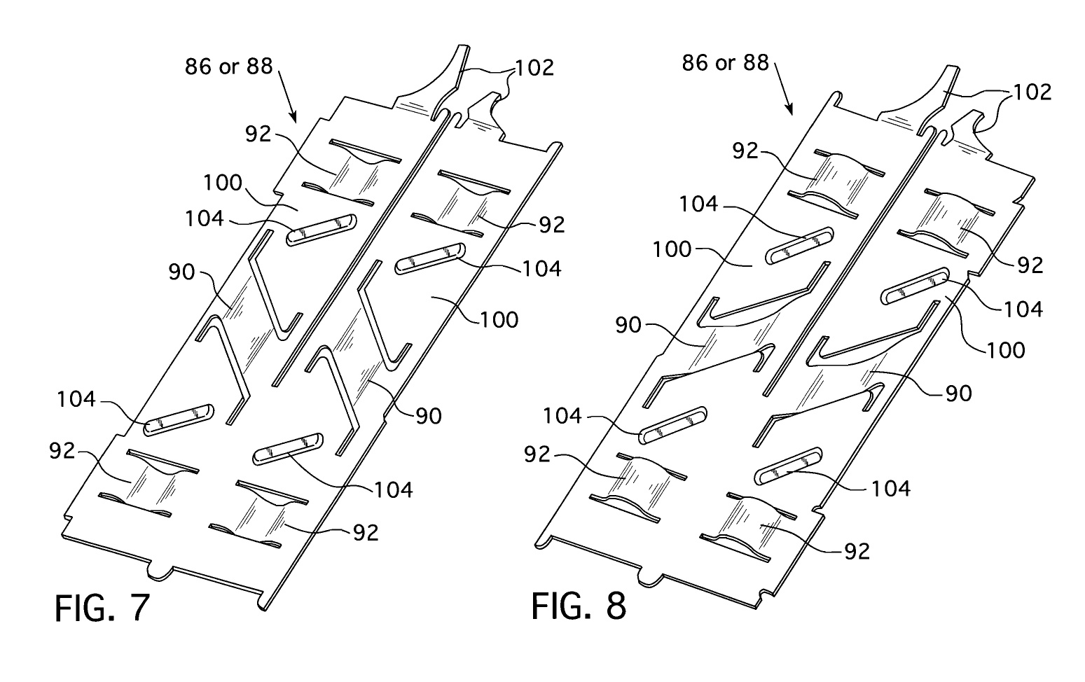

In accordance with the embodiments described herein, the crush strength of the spacer grid walls are increased by adding one or more embossed ribs 104 on one or more of the walls 100 as illustrated in FIGS. 5, 6, 7 and 8. FIGS. 6 and 8 present a rear view, respectively, of FIGS. 5 and 7. Preferably, the embossed ribs 104 extend in a horizontal direction in between the intersection of the orthogonal straps that define the fuel support cells 94. Desirably, the ribs 104 are on either side of the springs 90 between the dimples 92 and springs 90. However, it should be appreciated that one or more of the ribs 104 may be provided on one or more of the walls 100 to add strength to the grid straps 86 or 88. Furthermore, the ribs 104 may be provided at an orientation other than the horizontal orientation illustrated in FIGS. 5 and 6, as shown in FIGS. 7 and 8, in which the ribs extend on a diagonal. The shallow dome or cylinder type of ribs 104 illustrated in the figures can easily be formed during the strap stamping process without adding much additional cost to the manufacturing process. To prevent any excessive pressure drop increase, preferably the edges of the ribs 104 should be streamlined as illustrated in FIGS. 5-8, on the upstream side of the coolant and, desirably, all of the edges of the ribs should be streamlined. Also, the embossed ribs 104 can be oriented in alternate directions to minimize strap bowing or fanning, i.e., on alternate sides of the grid cell strap in adjacent cells. The ribs of this invention will prevent or minimize any undesirable deformation during the stamping process used to form the dimples and springs. Undesirable deformation of the thin plate straps that form the walls of the fuel rod support cells has been experienced in the past. The deformation makes it difficult to assemble the straps to be welded at the intersecting joints. In the past the straps were hammered to overcome this difficulty. The ribs of this invention obviate the need for the additional hammering step. Based on conventional Euler buckling theory, the buckling strength is a linear function of the moment of inertia. Therefore, the increase moment of inertia introduced by the embossed ribs 104 will enhance the crush strength of the space grid.

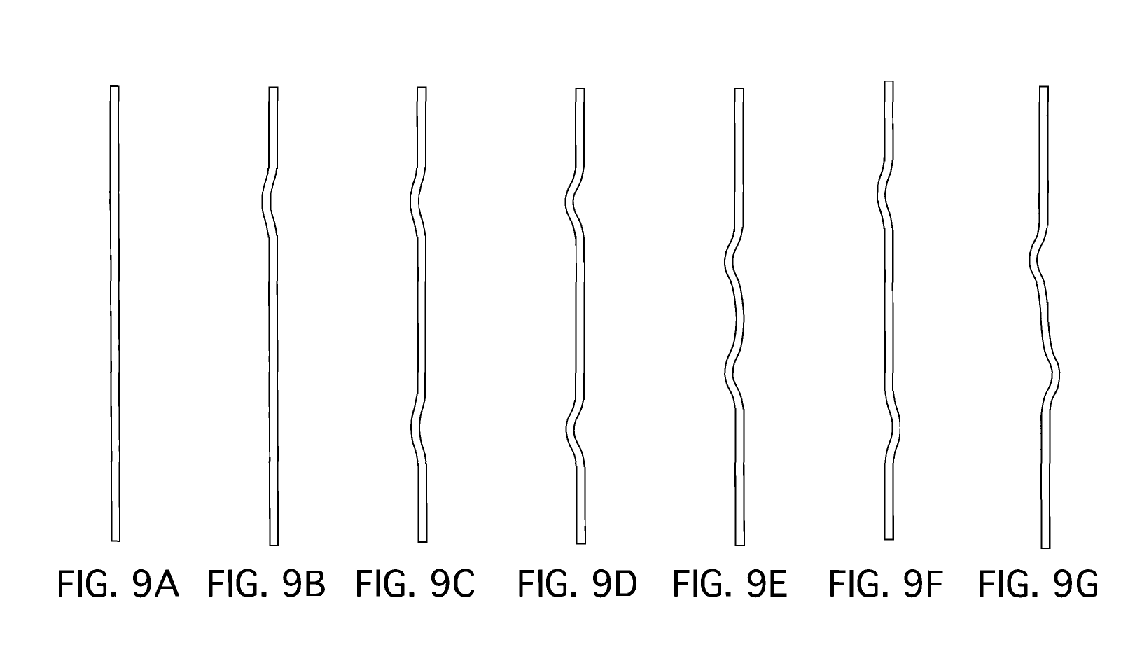

Based on a strap height, the moment of inertia is a function of the geometry, location, direction, and number of ribs as shown in Table 1 below.

| FIGS. 9 | 9A | 9B | 9C | 9D | 9E | 9F | 9G |
|---|---|---|---|---|---|---|---|
| Type (inch) | Straight | Single Rib | Double Rib | Double Rib | Double Rib | Double Rib | Double Rib |
| | (1.5 × 0.018) | Shape A | Shape A | Shape B | Shape B | Shape A | Shape B |
| | | Location A | Location A | Location A | Location B | Location A | Location B |
| | | Direction A | Direction A | Direction A | Direction A | Direction B | Direction B |
| Moment of Inertia | 7.3 | ~26.8 | ~44.7 | ~51.6 | ~51.6 | ~57.3 | ~66.5 |
| (×10⁻⁷ inch⁴) | | | | | | | |
| Projected Area | 3.6 | 11.1 | 11.1 | 12.3 | 12.3 | 13.7 | 21.0 |
| (×10⁻³ inch² | | | | | | | |

Table 1 corresponds to the rib configurations illustrated in FIGS. 9A-9G, showing the approximate moment of inertia and projected area of the ribs for each of the configurations illustrated. FIG. 9A shows a straight strap without any ribs as a point of reference. FIG. 9B shows a single rib having a shape A, location A in the upper region of the strap and a direction A, i.e., protruding to the left side of the strap. FIG. 9C shows a double rib configuration having the shape A, at location A, albeit in the upper and lower regions of the strap, in direction A. FIG. 9D shows a double rib configuration of shape B, i.e., having a sharper angle than that of shape A, at location A, in direction A. FIG. 9E shows a double rib configuration of shape B, at location B, i.e., more to the center of the strap, in direction A. FIG. 9F shows a double rib configuration of shape A, location A and in direction B, i.e., protruding on either side of the strap. FIG. 9G shows a double rib configuration of shape B, at location B, in direction B. Thus, the parameters in Table 1 can be optimized by satisfying the pressure drop allowance limit since a higher moment of inertia grid strap design could lead to a higher pressure drop. Another consideration is the manufacturing concerns regarding cracking, bowing and fanning during strap stamping.

Thus, this invention will enhance the crush strength of a spacer grid without increasing the height of the strap and/or adding additional, meaningful, manufacturing expense.

Accordingly, while specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear fuel assembly comprising:
a parallel array of elongated fuel elements:
a support grid for supporting the elongated fuel elements along their longitudinal dimension, the grid having a lattice structure which defines a plurality of cells, some of through which the fuel elements are respectively supported, others of which respectively support a guide tube for a control rod, each of the cells having a plurality of walls which intersect at corners and surround the corresponding fuel element or a guide tube at the support locations: and
wherein at least one wall of each cell that supports the fuel elements has an elongated rib formed from an indentation within the wall that is an integral part of the wall without substantially any perforations along the periphery of the indentation.

2. The nuclear fuel assembly of claim 1 wherein the elongated rib is oriented substantially horizontally.

3. The nuclear fuel assembly of claim 2 wherein the elongated rib extends substantially the entire width between corners.

4. The nuclear fuel assembly of claim 3 wherein the indentation is discontinued substantially at the corners.

5. The nuclear fuel assembly of claim 3 wherein the walls of each of the cells that support fuel elements has an upstream end and a downstream end, wherein the upstream end first encounters a reactor coolant flow when the fuel assembly is situated in an operating reactor and wherein the surfaces of the indentation are rounded on the upstream side of the indentation.

6. The nuclear fuel assembly of claim 5 wherein substantially all of the surfaces of the indentation are rounded.

7. The nuclear fuel assembly of claim 1 wherein the at least one wall has a plurality of the elongated ribs.

8. The nuclear fuel assembly of claim 1 wherein the lattice structure comprises two parallel arrays of intersecting straps wherein the walls on a strap of adjacent cells that support fuel elements have the elongated rib formed in different directions.

9. The nuclear fuel assembly of claim 1 wherein all of the walls of each cell that supports the fuel elements has the elongated rib.

10. The nuclear fuel assembly of claim 7 wherein the plurality of elongated ribs are positioned on either side of a spring or dimple that extends from the wall that the indentation is part of.

11. A support grid for supporting elongated nuclear fuel elements along their longitudinal dimension, the grid comprising:
a lattice structure which defines a plurality of cells, some of through which the fuel elements are respectively supported, others of which respectively support a guide tube for a control rod, each of the cells having a plurality of walls which intersect at corners and surround the corresponding fuel element or a guide tube at the support locations: and
wherein at least one wall of each cell that supports the fuel elements has an elongated rib formed from an indentation within the wall that is an integral part of the wall without substantially any perforations along the periphery of the indentation.

12. The support grid of claim 11 wherein the elongated rib is oriented substantially horizontally.

13. The support grid of claim 12 wherein the elongated rib extends substantially the entire width between corners.

14. The support grid of claim 13 wherein the indentation is discontinued substantially at the corners.

15. The support grid of claim 13 wherein the walls of each of the cells that support fuel elements has an upstream end and a downstream end, wherein the upstream end first encounters a reactor coolant flow when the fuel assembly is situated in an operating reactor and wherein the surfaces of the indentation are rounded on the upstream side of the indentation.

16. The support grid of claim 15 wherein substantially all of the surfaces of the indentation are rounded.

17. The support grid of claim 11 wherein the at least one wall has a plurality of the elongated ribs.

18. The support grid of claim 17 wherein the plurality of elongated ribs are positioned on either side of a spring or dimple that extends from the wall that the indentation is part of.

19. The support grid of claim 11 wherein the lattice structure comprises two parallel arrays of intersecting straps wherein the walls on a strap of adjacent cells that support fuel elements have the elongated rib formed in different directions.

20. The support grid of claim 11 wherein all of the walls of each cell that supports the fuel elements has the elongated rib.
